(19) United States
(12) Patent Application Publication
(10) Pub. No.: US 2016/0043955 A1
(43) Pub. Date: Feb. 11, 2016

(54) DELIVERY OF PROTOCOL DATA UNITS

(71) Applicant: NOKIA SOLUTIONS AND NETWORKS OY, Espoo (FI)

(72) Inventor: Henri Markus KOSKINEN, Espoo (FI)

(21) Appl. No.: 14/919,534

(22) Filed: Oct. 21, 2015

Related U.S. Application Data
(62) Division of application No. 14/067,509, filed on Oct. 30, 2013.
Application No. 14/067,509 is a continuation-in-part of application No. 13/856,951, filed on Apr. 4, 2013, now abandoned.

(51) Int. Cl. H04L 12/851; H04L 12/801

(52) U.S. Cl. CPC H04L 47/2408; H04L 47/34

(57) ABSTRACT

Delivery of protocol data units or other suitable data or information units in various communication systems can be enhanced by appropriate methods and devices. For example, in-sequence delivery of protocol data units received in parallel from several lower-layer acknowledged-mode protocol entities may benefit from timers and/or forwarding status reports. A method can include observing a gap in a sequence of protocol data units received from a plurality of lower-layer protocol entities providing data transfer. The method can also include starting a timer upon the gap observation. The method can further include preventing the gap from blocking delivery of service data units to a higher layer, when the timer expires. The method can additionally include detecting a forwarding-status report. The method can also include immediately proceeding with data delivery to higher layer, containing the gaps because of the lack of forwarding at handover.

### CROSS REFERENCE TO RELATED APPLICATIONS

The present application is a divisional application of U.S. patent application Ser. No. 14/067,509, filed on Oct. 30, 2013, which is a continuation-in-part of U.S. patent application Ser. No. 13/856,951, filed on Apr. 4, 2013. The contents of each of these applications are hereby incorporated herein by reference in their entirety.

### BACKGROUND

1. Field

Delivery of protocol data units or other suitable data or information units in various communication systems can be enhanced by appropriate methods and devices. For example, in-sequence delivery of protocol data units received in parallel from several lower-layer acknowledged-mode protocol entities may benefit from reordering timers and/or forwarding status reports. Moreover, in-sequence delivery of protocol data units (PDUs) received in parallel from several lower-layer acknowledged-mode protocol entities may benefit from a data PDU containing no service data unit (SDU) for expediting data delivery to higher layer at receiving protocol entity.

2. Description of the Related Art

In the Evolved Universal Terrestrial Radio Access Network (E-UTRAN) air-interface protocol stack, the Packet Data Convergence Protocol (PDCP) currently lies above the Radio Link Control (RLC) protocol. PDCP is currently defined by third generation partnership project (3GPP) technical specification (TS) 36.323, which is hereby incorporated herein by reference. RLC is defined by 3GPP TS 36.322, which is hereby incorporated herein by reference.

For PDCP, the listed ‘Services expected from lower layers’ include among others: acknowledged data transfer service, including indication of successful delivery of PDCP protocol data units and in-sequence delivery, except at re-establishment of lower layers.

Correspondingly, the following PDCP ‘Function’ is listed: in-sequence delivery of upper layer PDUs at re-establishment of lower layers.

In studies of dual connectivity in E-UTRAN, protocol stacks may be based on having independent RLC in each node for dual connectivity. FIG. 1 illustrates control/user (C/U)-plane protocol stacks. More specifically, FIG. 1 illustrates multi-radio U-plane protocol stacks for offloading or inter-site carrier aggregation.

On stage-2 level, the work-split in in-sequence delivery between PDCP and RLC exhibits itself, for example, as follows in 3GPP TS 36.300 §§10.1.2.3 and 10.1.2.3.1, which is hereby incorporated herein by reference. “Upon handover, the source eNB may forward in order to the target eNB all downlink PDCP SDUs [service data units] with their SN that have not been acknowledged by the UE . . . . After a normal handover, when the UE receives a PDCP SDU from the target eNB, it can deliver it to higher layer together with all PDCP SDUs with lower SNs regardless of possible gaps.”

The possible gaps mentioned above may occur because, after handover, the PDCP at the UE may receive PDUs whose reception failed before the handover, but only if they were forwarded by the source eNB to the target eNB. In any case, the PDCP at the UE is allowed to assume that PDUs received after the handover arrive in increasing order of PDUs' sequence numbers.

The stage-3 realization of this principle looks as follows in 3GPP TS 36.323 §§5.1.2, 5.1.2.1, and 5.1.2.1.2: “ . . . if the PDCP PDU received by PDCP is not due to the re-establishment of lower layers: deliver to upper layers in ascending order of the associated COUNT value: all stored PDCP SDU(s) with an associated COUNT value less than the COUNT value associated with the received PDCP SDU; all stored PDCP SDU(s) with consecutively associated COUNT value(s) starting from the COUNT value associated with the received PDCP SDU . . . . ”

Thus, unless the PDU was flushed by RLC re-establishment, performed at handover to deliver all received RLC SDUs ciphered with the source eNB's key, the system assumes that no PDU with lower SN will follow after the one received, and deliver SDUs to higher layer accordingly.

Continuing from the same 3GPP TS: “ . . . set Last_Submitted_PDCP_RX_SN to the PDCP SN of the last PDCP SDU delivered to upper layers; else if received PDCP SN=Last_Submitted_PDCP_RX_SN+1 or received PDCP SN=Last_Submitted_PDCP_RX_SN−Maximum_PDCP_SN: deliver to upper layers in ascending order of the associated COUNT value: all stored PDCP SDU(s) with consecutively associated COUNT value(s) starting from the COUNT value associated with the received PDCP SDU; set Last_Submitted_PDCP_RX_SN to the PDCP SN of the last PDCP SDU delivered to upper layers.”

Thus, if the PDU was flushed by RLC re-establishment, the system refrains from any SDU delivery to higher layer that would leave a hole in the SN sequence of delivered SDUs.

Accordingly, in the conventional procedure above, there are two branches, the first of which assumes that no unreceived PDU with lower SN can be expected after the one received: the only exception to this assumption—the second branch—is when PDUs are received due to RLC re-establishment.

Another protocol-architecture option involves a distributed RLC protocol where, with reference to FIG. 1, the PDCP entity at the eNB interfaces a co-located master RLC entity: this master RLC may divide the RLC PDUs destined towards the UE into those meant for a direct radio-interface transmission via the co-located MAC/PHY layers, in the case of what is called dual-radio mode, and to those to be transmitted by a slave RLC entity operating at the LTE-Hi AP. As in the previously discussed model, in this option there is one-to-one mapping between PDCP bearers and RLC bearers with data flow in given direction.

According to 3GPP TS 36.322, each receiving unacknowledged-mode RLC entity implements the following: VR(UR)—UM receive state variable, VR(UX), UM t-Reordering state variable, VR(UH)—UM highest received state variable, and t-Reordering. VR(UR)—UM receive state variable can hold the value of the SN of the earliest UMD PDU that is still considered for reordering. VR(UX)—UM t-Reordering state variable can hold the value of the SN following the SN of the UMD PDU which triggered t-Reordering. VR(UH)—UM highest received state variable can hold the value of the SN following the SN of the UMD PDU with the highest SN among received UMD PDUs, and it serves as the higher edge of the reordering window. t-Reordering is a timer that is used by the receiving side of an AM RLC entity and receiving UM RLC entity in order to detect loss of RLC PDUs at lower layer.

3GPP TS 36.322, §5.1.2.2.4 explains actions when t-Reordering expires. Specifically, 3GPP TS 36.322 explains that “When t-Reordering expires, the receiving UM RLC entity shall: update VR(UR) to the SN of the first UMD PDU with SN>=VR(UX) that has not been received; reassemble RLC SDUs from any UMD PDUs with SN<updated VR(UR), remove RLC headers when doing so and deliver the reassembled RLC SDUs to upper layer in ascending order of the RLC SN if not delivered before; if VR(UH)>VR(UR): start t-Reordering; set VR(UX) to VR(UH).”

Conventionally, a packet data convergence protocol (PDCP) data PDU can be used to convey a PDCP SDU SN; and user plane data containing an uncompressed PDCP SDU; or user plane data containing a compressed PDCP SDU; or control plane data; and a MAC-I field for SRBs; or for RNs, a MAC-I field for DRB (if integrity protection is configured).

Conventionally, PDCP may not wait for PDUs missing among those received, except at radio link control (RLC) re-establishment. Thus, a gap generated by PDCP discard at the eNB can be immediately seen in TCP/IP at the UE. Consequently, the UE may send a duplicate TCP ACK and the network side TCP may slow down.

Higher layer small cell layer enhancements are described, for example, in 3GPP technical report (TR) 36.842 v.0.3.0, which is hereby incorporated herein by reference in its entirety. For example, option 3C in the technical report describes a U-plane protocol architecture that may be used.

### SUMMARY

According to a first embodiment, a method includes observing a gap in a sequence of protocol data units received from a plurality of lower-layer protocol entities providing data transfer. The method also includes starting a timer upon the gap observation. The method further includes preventing the gap from blocking delivery of service data units to a higher layer, when the timer expires.

In a variation, the method includes detecting a forwarding-status report and immediately proceeding with data delivery to higher layer, containing the gaps because of the lack of forwarding at handover.

According to a second embodiment, a method includes determining which protocol data unit sequence numbers will not be forwarded to a user equipment. The method also includes explicitly identifying the protocol data unit sequence numbers to the user equipment in a report.

According to a third embodiment, an apparatus includes at least one processor and at least one memory including computer program code. The at least one memory and the computer program code are configured to, with the at least one processor, cause the apparatus at least to observe a gap in a sequence of protocol data units received from a plurality of lower-layer protocol entities providing data transfer. The at least one memory and the computer program code are also configured to, with the at least one processor, cause the apparatus at least to start a timer upon the gap observation. The at least one memory and the computer program code are further configured to, with the at least one processor, cause the apparatus at least to prevent the gap from blocking delivery of service data units to a higher layer, when the timer expires.

In a variation, the at least one memory and the computer program code are configured to, with the at least one processor, cause the apparatus at least to detect a forwarding-status report and immediately proceed with data delivery to higher layer, containing the gaps because of the lack of forwarding at handover.

According to a fourth embodiment, an apparatus includes at least one processor and at least one memory including computer program code. The at least one memory and the computer program code are configured to, with the at least one processor, cause the apparatus at least to determine which protocol data unit sequence numbers will not be forwarded to a user equipment. The at least one memory and the computer program code are also configured to, with the at least one processor, cause the apparatus at least to explicitly identify the protocol data unit sequence numbers to the user equipment in a report.

According to a fifth embodiment, an apparatus includes observing means for observing a gap in a sequence of protocol data units received from a plurality of lower-layer protocol entities providing data transfer. The apparatus also includes starting means for starting a timer upon the gap observation. The apparatus further includes preventing means for preventing the gap from blocking delivery of service data units to a higher layer, when the timer expires.

In a variation, the apparatus includes detecting means for detecting a forwarding-status report and delivery means for immediately proceeding with data delivery to higher layer, containing the gaps because of the lack of forwarding at handover.

According to a sixth embodiment, an apparatus includes determining means for determining which protocol data unit sequence numbers will not be forwarded to a user equipment. The method also includes identifying means for explicitly identifying the protocol data unit sequence numbers to the user equipment in a report.

According to a seventh embodiment, a method can include receiving a protocol data unit with a sequence number but without a service data unit having a non-zero size. The method can also include preventing absence of a service data unit having a non-zero size and an association with the sequence number from blocking delivery of service data units to a higher layer.

According to an eighth embodiment, a method can include determining a service data unit that will not be delivered to a data-receiving entity. The service data unit can be associated with a sequence number. The method can also include sending a protocol data unit including the sequence number but excluding the service data unit.

According to a ninth embodiment, an apparatus can include at least one processor and at least one memory including computer program code. The at least one memory and the computer program code can be configured to, with the at least one processor, cause the apparatus at least to receive a protocol data unit with a sequence number but without a service data unit having a non-zero size. The at least one memory and the computer program code can be configured to, with the at least one processor, cause the apparatus at least to prevent absence of a service data unit having a non-zero size and an association with the sequence number from blocking delivery of service data units to a higher layer.

According to a tenth embodiment, an apparatus can include at least one processor and at least one memory including computer program code. The at least one memory and the computer program code can be configured to, with the at least one processor, cause the apparatus at least to determine a service data unit that will not be delivered to a data-receiving entity. The service data unit can be associated with a sequence number. The at least one memory and the computer program code can be configured to, with the at least one processor, cause the apparatus at least to send a protocol data unit including the sequence number but excluding the service data unit.

According to an eleventh embodiment, an apparatus can include means for receiving a protocol data unit with a sequence number but without a service data unit having a non-zero size. The apparatus can also include means for preventing absence of a service data unit having a non-zero size and an association with the sequence number from blocking delivery of service data units to a higher layer.

According to a twelfth embodiment, an apparatus can include means for determining a service data unit that will not be delivered to a data-receiving entity. The service data unit can be associated with a sequence number. The apparatus can also include sending a protocol data unit including the sequence number but excluding the service data unit.

According to thirteenth through sixteenth embodiments, respectively, a non-transitory computer-readable medium is encoded with instructions that, when executed in hardware, perform a process. The process is respectively the method of the first embodiment, the second embodiment, the seventh embodiment, and the eighth embodiment, in any of their variations.

According to seventeenth through twentieth embodiments, respectively, a computer program comprising program instructions which, when loaded into the apparatus, cause a computer system to perform the method of the first embodiment, the second embodiment, the seventh embodiment, and the eighth embodiment, in any of their variations.

### BRIEF DESCRIPTION OF THE DRAWINGS

For proper understanding of the invention, reference should be made to the accompanying drawings, wherein:

FIG. 1 illustrates a protocol-architecture option involving independent RLC protocol bearers serving a single PDCP bearer.

FIG. 2 illustrates a method according to certain embodiments.

FIG. 3 illustrates timer usage according to certain embodiments.

FIG. 4 illustrates forwarding-status report handling according to certain embodiments.

FIG. 5 illustrates a system according to certain embodiments.

### DETAILED DESCRIPTION

There may be various ways to get a sending TCP device on a network side of base station, such as an evolved Node B (eNB), to slow down. One way may be to use Packet Data Convergence Protocol (PDCP) discard of data units at the base station. The base station may seek to get a sending TCP device to slow down when the data rate of the sending TCP device exceeds that of a radio interface of the base station. For example, this discarding can be useful when the eNB's transmit buffer starts to build up.

If the layer responsible for reordering is the same layer or higher than where such packet discarding takes place, then the reordering protocol may not be able to distinguish packets discarded at the transmitting side from packets still being processed at lower layers. There may, for example, be multiple alternative delivery branches, such as macro eNB (MeNB) and small cell eNB (SeNB), both possibly being scheduled intermittently.

There may be various options for the receiving PDCP at the UE to decide when to pass received data to a higher layer, even though an SDU with a certain sequence number has not been received. For example, a reordering timer may be used. This reordering timer may need to have a long expiry value. Alternatively, the PDCP may by default prevent itself from delivering, to a higher layer, any data that follows PDUs not yet received. Whether the data follows or not may be established by sequence number.

Both options may benefit from an explicit indication from the sending PDCP entity to the receiving PDCP entity. This indication can specify that an SDU associated with a given SN is not to be expected. This and other features are explained in the following discussion.

In certain embodiments, unlike in E-UTRAN's current bearer model, the PDCP bearer terminated at the user equipment and the eNB is carried over two independent RLC bearers, one over each of the two radio interfaces of the user equipment. Thus, in certain embodiments, the bearer is an acknowledged-mode (AM) bearer. In this discussion, eNB is one example of an access point.

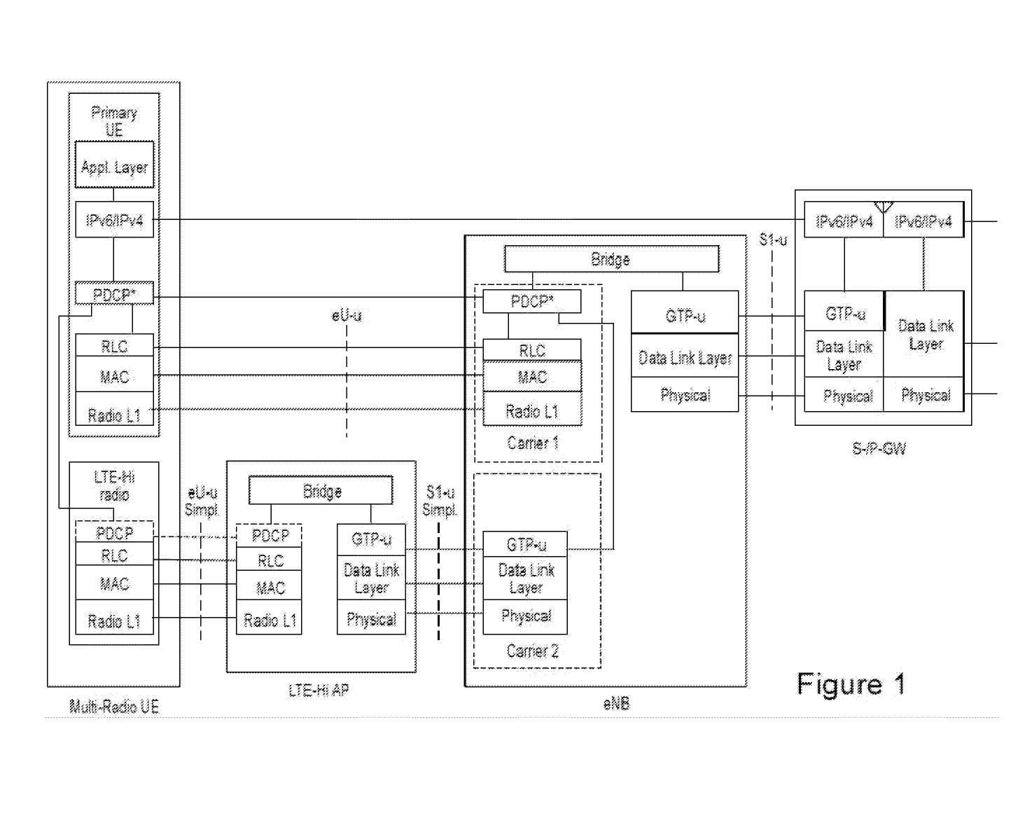

When considering the renewed bearer model shown in FIG. 1, where a plurality of independent RLC-AM bearers may be harnessed to convey data of a PDCP bearer, the PDCP entity at the user equipment may be bound to receive PDCP protocol data units from multiple underlying RLC entities in a highly interlaced manner. In other words, conditions where the assumption holds, that no unreceived PDU with lower SN can be expected after the one received, become a rare exception, rather than the rule. The only exception may be created by inter-eNB handover of the network-side PDCP entity, where the source eNB does not carry out forwarding of PDCP protocol data units not yet successfully delivered to the user equipment. But this exception may need to be handled properly: if the PDCP at the user equipment always waits for reception gaps to be filled before delivery of data to higher layer, then at a handover without forwarding the bearer may go into deadlock, because the gaps created by packets that were not forwarded will never be received.

Certain embodiments provide apparatuses and methods for the PDCP entity at the user equipment to deduce when not to expect reception gaps to be filled.

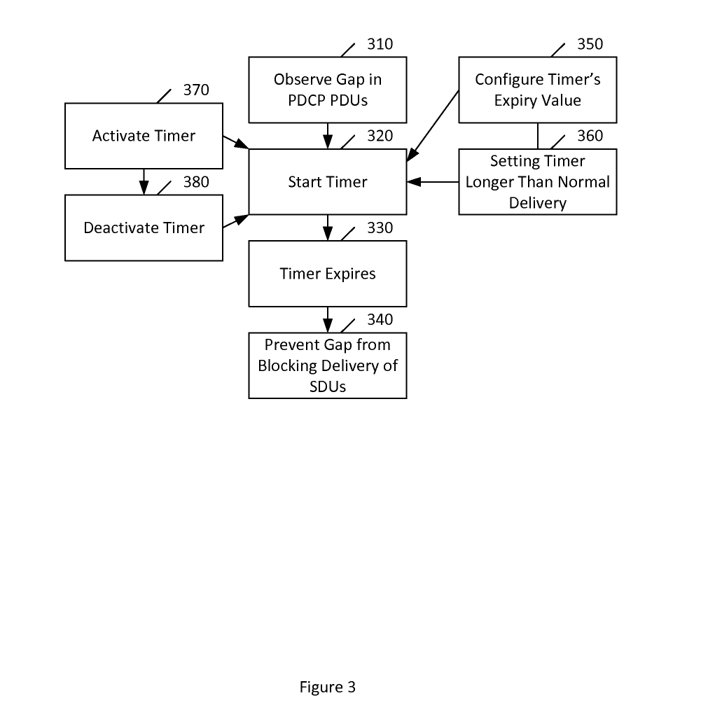

For example, certain embodiments utilize a timer, such as a reordering timer, as shown in FIG. 3. In order for the PDCP entity, receiving protocol data units from a plurality of RLC-AM entities running below, to conclude when a gap in received protocol data units can no longer be expected to be filled, the timer and its handling, along with the related state variables needed, that are currently specified for RLC-UM can be repurposed for AM data transfer.

As shown in FIG. 3, a timer, such as a reordering timer, can be started at 320 whenever a gap in the received protocol data units is observed at 310, such as by observing a gap in a sequence of protocol data units. The protocol data units may be received from a plurality of lower-layer protocol entities providing data transfer. The protocol data units may be received in an alternating fashion. Each of the lower-layer entities may provide acknowledged transfer of protocol data units. Once the timer expires at 330, that gap is no longer allowed to block delivery of service data units to higher layer, at 340. A state variable like VR(UX) can be introduced in PDCP, whereas state variables like VR(UR) and VR(UH) may have simple relations to the currently existing PDCP state variables Last_Submitted_PDCP_RX_SN and Next_PDCP_RX_SN, respectively. Preventing the block of delivery can be carried out by proceeding with the delivery of service data units to the higher layer without a delay caused by waiting for protocol data units. Reception of the protocol data units from more than one lower-layer protocol entities can be at least substantially parallel in nature and the plurality of lower-layer protocol entities can be acknowledged-mode protocol entities.

The timer's expiry value can be configured by radio resource control (RRC) at 350, and can be set at 360 long enough so that the timer does not expire during normal delivery delay of protocol data units sent by the eNB to the user equipment via a small-cell node, for example, including all possible HARQ and ARQ retransmissions at MAC and RLC level therein, respectively. Because of this need to set the timer expiry to fairly long values, in the case of inter-eNB handover where the source does not forward PDCP Service data units and hence gaps will remain, the data delivery to higher layer by the user equipment will be considerably delayed.

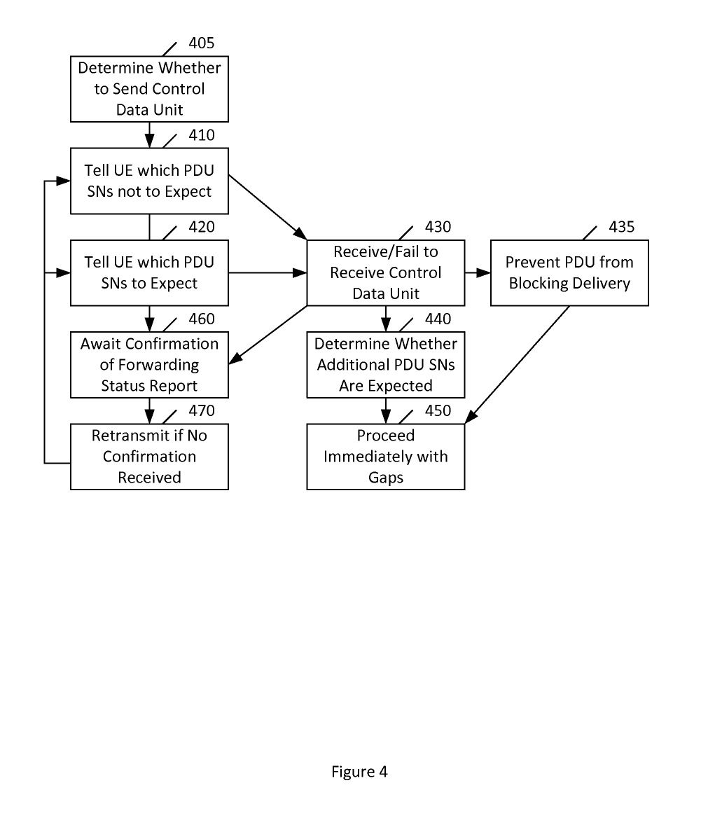

Moreover, certain embodiments utilize a forwarding-status report to shorten the delay described above. FIG. 4 illustrates forwarding-status report handling according to certain embodiments. A forwarding-status report can be a new PDCP control PDU by which the network, for example the handover-target eNB, can explicitly tell the user equipment (after handover) at 410, which protocol data unit sequence numbers (PDU SNs) the user equipment should not expect to receive at all. Optionally, at 420 the forwarding-status report can possibly also tell the user equipment (after handover), which protocol data unit sequence numbers the user equipment should expect to receive. Thus, at 410, a control data unit, such as a forwarding status report, can be sent identifying at least one protocol data unit that should not be expected to be received.

The information received, at 430, in such a report by the user equipment can then override any prevailing uncertainty regarding the concerned unreceived protocol data units because of which timer may already be running as the user equipment can determine at 440 whether additional protocol data unit sequence numbers are expected. At 435, the method can include preventing the at least one identified protocol data unit from blocking delivery of service data units to a higher layer. The user equipment can immediately proceed, at 450, with data delivery to a higher layer, containing gaps because of the lack of forwarding at handover. In cases where the handover-target eNB observes that no gap in SNs should occur in the PDCP protocol data units delivered to the user equipment, it can simply refrain from sending such a report. Thus, at 405, a determination regarding whether to send the report can be made. At 435, the at least one identified protocol data unit is prevented from blocking delivery of service data units to a higher layer.

In principle, the timer can be used independently of the forwarding status report. The timer may introduce additional, continuously running procedures for a protocol entity to execute. Those procedures may only change operation, for example when a gap among received protocol data units proves permanent, in a scenario in which a handover exists without forwarding. Activation of the feature, at 370, for example by radio resource control when a handover command is received, is one option. Conventionally, PDCP does not know if PDCP re-establishment is invoked because of handover. Moreover, at 380, deactivation of the feature can be performed by an indication from the peer PDCP entity at the handover-target eNB, that possible gaps no longer occur in protocol data units' SNs after an indicated SN. This indication may be considered one form of forwarding-status report. The possibility of having the feature either active or inactive may require separate branches in procedure descriptions.

Relying on a forwarding-status report alone may require that its reception by the user equipment be made certain, since losing such a report in transit may mean that the PDCP at the user equipment goes into deadlock waiting for reception gaps to be filled, which never will. Possible options to ensure delivery may include features such as relying on an underlying acknowledged-mode delivery of RLC AM and/or requiring explicit acknowledgement of reception of the forwarding-status report at PDCP level, for which the sending node can await confirmation at 460. A PDCP Control PDU may be defined for the purpose. Moreover, the forwarding-status report can be retransmitted at 470 if no acknowledgement is received within a predetermined amount of time.

Certain embodiments, thus, provide apparatuses and methods for when a PDCP entity receiving protocol data units from multiple RLC-AM entities should and should not assume gap-less reception of protocol data units, and how to deliver Service data units to higher layer accordingly.

In the certain embodiments in which both a timer and a forwarding-status report are included, the following features may be part of a PDCP procedure. For example, it may be specified that if reception of PDCP Data protocol data units from only one DRB mapped on RLC AM has been configured and the PDCP PDU received by PDCP is not due to the re-establishment of lower layers: deliver to upper layers in ascending order of the associated COUNT value: all stored PDCP SDU(s) with an associated COUNT value less than the COUNT value associated with the received PDCP SDU; all stored PDCP SDU(s) with consecutively associated COUNT value(s) starting from the COUNT value associated with the received PDCP SDU; set Last_Submitted_PDCP_RX_SN to the PDCP SN of the last PDCP SDU delivered to upper layers; else if received PDCP SN=Last_Submitted_PDCP_RX_SN+1 or received PDCP SN=Last_Submitted_PDCP_RX_SN−Maximum_PDCP_SN: deliver to upper layers in ascending order of the associated COUNT value: all stored PDCP SDU(s) with consecutively associated COUNT value(s) starting from the COUNT value associated with the received PDCP SDU; set Last_Submitted_PDCP_RX_SN to the PDCP SN of the last PDCP SDU delivered to upper layers. It should be understood that this is just one example embodiment.

In addition, t-Reordering and a state variable like VR(UX) can be handled similar to what is shown in 3GPP TS 36.322 sections 5.1.2.2.3, 5.1.2.2.4, which are hereby incorporated herein by reference.

Furthermore, it can be specified that, regarding the reception of PDCP forwarding-status report, when a PDCP forwarding-status report is received in the downlink, for radio bearers that are mapped on RLC AM: for each PDCP SN [or COUNT value] indicated in the report as not to be expected for reception, the user equipment shall update all related state variables and t-Reordering as further specified, and deliver other Service data units to higher layer, as if a PDCP Data PDU with that PDCP SN was received.

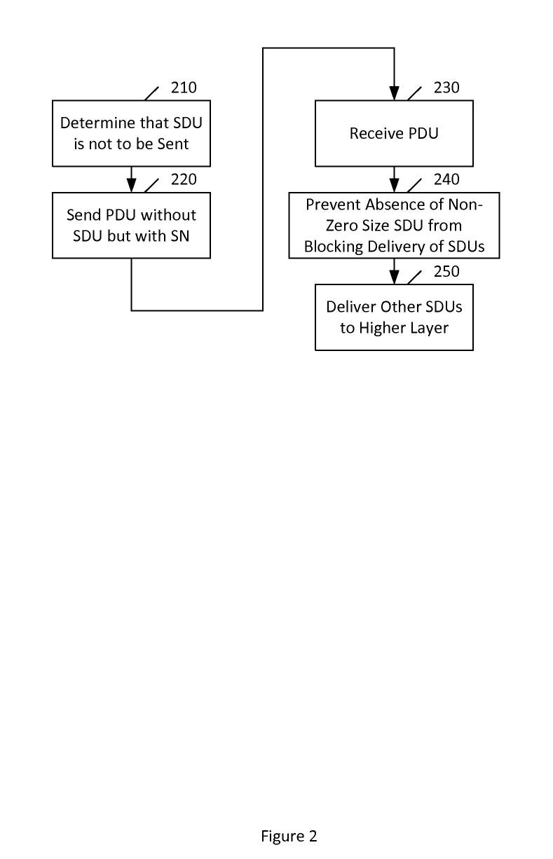

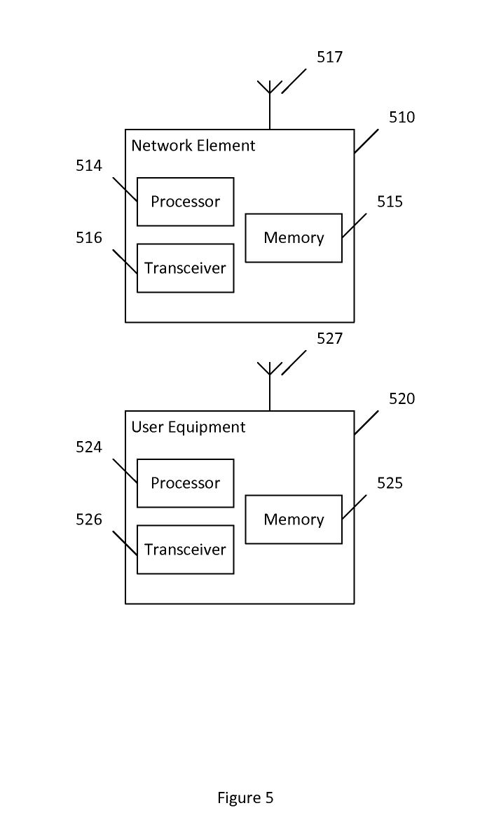

FIG. 5 illustrates a system according to certain embodiments of the invention. It should be understood that each block of the flowchart of FIG. 2, 3, or 4 and any combination thereof may be implemented by various means or their combinations, such as hardware, software, firmware, one or more processors and/or circuitry. In one embodiment, a system may comprise several devices, such as, for example, network element 510 and user equipment (UE) or user device 520. The system may comprise more than one UE 520 and more than one network element 510, although only one of each is shown for the purposes of illustration. A network element can be an access point, a base station, an eNode B (eNB), server, host or any of the other network elements discussed herein. Each of these devices may comprise at least one processor or control unit or module, respectively indicated as 514 and 524. At least one memory may be provided in each device, and indicated as 515 and 525, respectively. The memory may comprise computer program instructions or computer code contained therein. One or more transceiver 516 and 526 may be provided, and each device may also comprise an antenna, respectively illustrated as 517 and 527. Although only one antenna each is shown, many antennas and multiple antenna elements may be provided to each of the devices. Other configurations of these devices, for example, may be provided. For example, network element 510 and UE 520 may be additionally configured for wired communication, in addition to wireless communication, and in such a case antennas 517 and 527 may illustrate any form of communication hardware, without being limited to merely an antenna. Likewise, some network elements 510 may be solely configured for wired communication, and such cases antenna 517 may illustrate any form of wired communication hardware, such as a network interface card.

Transceivers 516 and 526 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. It should also be appreciated that according to the “liquid” or flexible radio concept, the operations and functionalities may be performed in different entities, such as nodes, hosts or servers, in a flexible manner. In other words, “division of labour” may vary case by case. One possible use is to make a network element to deliver local content. One or more functionalities may also be implemented as a virtual application that is as software that can run on a server.

A user device or user equipment may be a mobile station (MS) such as a mobile phone or smart phone or multimedia device, a computer, such as a tablet, provided with wireless communication capabilities, personal data or digital assistant (PDA) provided with wireless communication capabilities, portable media player, digital camera, pocket video camera, navigation unit provided with wireless communication capabilities or any combinations thereof.

In an exemplary embodiment, an apparatus, such as a node or user device, may comprise means for carrying out embodiments described above in relation to FIG. 2, 3, or 4. In an exemplary embodiment, an apparatus, such as a user device, may comprise means (524) for observing a gap in received protocol data units, starting a timer upon the gap observation and preventing the gap from blocking delivery of service data units to a higher layer, when the timer expires. Another exemplary apparatus, such as a node, may comprise means (514) for determining which protocol data unit sequence numbers will not be forwarded to user equipment; and explicitly identifying the protocol data unit sequence numbers to the user equipment in a report.

Processors 514 and 524 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors.

For firmware or software, the implementation may comprise modules or unit of at least one chip set (e.g., procedures, functions, and so on). Memories 515 and 525 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 510 and/or UE 520, to perform any of the processes described above (see, for example, FIGS. 2, 3, and 4). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 5 illustrates a system including a network element 510 and a UE 520, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

Certain embodiments provide a particular case of PDCP Data PDU to be used over a standardized LTE air interface.

FIG. 2 illustrates a method according to certain embodiments. As shown in FIG. 2, at 210, the data-transmitting PDCP entity can determine that an SDU associated with given PDCP sequence number will not be delivered to the peer protocol entity. This determination can be a decision made by the PDCP entity, for example, because of intentional discarding among already-numbered PDUs.

When the data-transmitting PDCP entity determines that an SDU associated with given PDCP sequence number will not be delivered to the peer protocol entity, at 220 the data-transmitting PDCP entity can send a PDCP data PDU, with that SN but without any SDU, to the peer entity. Alternatively, the SDU may be included but may have a zero size. The portion of the method at 210 and 220 can be performed by the data-transmitting PDCP entity, whereas the remainder of the method can be performed by a receiving peer entity.

At 230, the receiving peer entity can receive the PDU. When receiving such a PDU, the receiving peer entity can treat the PDU as though it included an SDU with zero length associated with that SN. This can be one example of how the receiving entity can, at 240, prevent the absence of a service data unit having a non-zero size and an association with the sequence number from blocking delivery of service data units to a higher layer. Therefore, the receiving peer entity can avoid waiting any longer for receiving that SN before, at 250, delivering other SDUs to a higher layer.

Certain embodiments may have various benefits and/or advantages. For example, in certain embodiments no additional PDCP PDU format needs to be introduced.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. For example, while a protocol data unit is used an example, certain embodiments are applicable not only to a protocol data unit but to any other suitable data or information unit. In order to determine the metes and bounds of the invention, therefore, reference should be made to the appended claims.

### GLOSSARY

ACK Positive acknowledgement

AM Acknowledged Mode

NACK Negative acknowledgement

RLC Radio Link Control

PDCP Packet Data Convergence Protocol

PDU Protocol Data Unit

SDU Service Data Unit

SN Sequence Number

UM Unacknowledged Mode

We claim:

1. A method, comprising:
receiving a control data unit, the control data unit identifying at least one protocol data unit that should not be expected to be received; and
preventing the at least one identified protocol data unit from blocking delivery of service data units to a higher layer.

2. The method of claim 1, wherein the identifying the at least one protocol data unit is carried out by using sequence numbers.

3. The method of claim 1, wherein the preventing is carried out by proceeding with the delivery of service data units to a higher layer without a delay caused by waiting for protocol data units.

4. The method of claim 1, wherein the control data unit identifies at least one protocol data unit that should be expected to be received.

5. An apparatus, comprising:
at least one processor; and
at least one memory including computer program code,
wherein the at least one memory and the computer program code are configured to, with the at least one processor, cause the apparatus at least to
receive a control data unit, the control data unit identifying at least one protocol data unit that should not be expected to be received; and
prevent the at least one identified protocol data unit from blocking delivery of service data units to a higher layer.

6. The apparatus of claim 5, wherein the at least one memory and the computer program code are configured to, with the at least one processor, cause the apparatus at least to identify the at least one protocol data unit by using sequence numbers.

7. The method of claim 5, wherein the at least one memory and the computer program code are configured to, with the at least one processor, cause the apparatus at least to prevent the blocking of delivery by proceeding with the delivery of service data units to a higher layer without a delay caused by waiting for protocol data units.

8. The apparatus of claim 5, wherein the control data unit is configured to identify at least one protocol data unit that should be expected to be received.

9. A non-transitory computer-readable medium encoded with instructions that, when executed in hardware, perform a process, the process comprising:
receiving a control data unit, the control data unit identifying at least one protocol data unit that should not be expected to be received; and
preventing the at least one identified protocol data unit from blocking delivery of service data units to a higher layer.

10. The non-transitory computer-readable medium of claim 1, wherein the identifying the at least one protocol data unit is carried out by using sequence numbers.

11. The non-transitory computer-readable medium of claim 1, wherein the preventing is carried out by proceeding with the delivery of service data units to a higher layer without a delay caused by waiting for protocol data units.

12. The non-transitory computer-readable medium of claim 1, wherein the control data unit identifies at least one protocol data unit that should be expected to be received.
